(19) United States
(12) Patent Application Publication
(10) Pub. No.: US 2025/0319708 A1
(43) Pub. Date: Oct. 16, 2025

(54) PRINTER

(71) Applicant: FCL COMPONENTS LIMITED, Tokyo (JP)

(72) Inventors: Tatsuya Oguchi, Tokyo (JP); Masafumi Chiba, Tokyo (JP); Hiroyuki Kataoka, Tokyo (JP); Tetsuhiro Ishikawa, Tokyo (JP); Yuji Yada, Tokyo (JP); Yuuya Ishii, Tokyo (JP)

(21) Appl. No.: 19/098,275

(22) Filed: Apr. 2, 2025

(30) Foreign Application Priority Data
Apr. 15, 2024 (JP) 2024-065089

(51) Int. Cl. B41J 11/70; B41J 11/66; B41J 29/13

(52) U.S. Cl. CPC B41J 11/706; B41J 11/663; B41J 29/13

(57) ABSTRACT

A printer includes: a printing part for printing on a recording sheet; a fixed blade and a movable blade for cutting the recording sheet; a body part supporting the movable blade; an opening and closing part supporting the fixed blade and having a first end connected to the body part such that the opening and closing part opens and closes; an opening and closing lever provided at a second end of the opening and closing part opposite the first end and rotating between a free position for allowing the opening and closing part to open and close and a locking position for fixing the opening and closing part to the body part; and a separating mechanism for separating the fixed blade from the movable blade in a separating direction in conjunction with an unlocking operation of the opening and closing lever.

### CROSS-REFERENCE TO RELATED APPLICATION

This application is based upon and claims the benefit of priority of prior Japanese Patent Applications No. 2024-065089, filed on Apr. 15, 2024, the entire contents of which are incorporated herein by reference.

### BACKGROUND

A certain aspect of the embodiments is related to a printer.

Some existing printers are designed to take a recording sheet from a paper roll, print on the recording sheet, and then cut the recording sheet appropriately. These printers are equipped with a conjunctional mechanism that moves a fixed blade away from a movable blade in conjunction with the operation of a lever part, so that the contact pressure between the fixed blade and the movable blade is released.

### RELATED ART

Patent Document 1: Unexamined Japanese Patent Application No. 2010-000549

### SUMMARY

According to one example of the present disclosure, a printer includes: a printing part configured to print on a recording sheet; a fixed blade and a movable blade configured to cut the recording sheet printed by the printing part; a body part that supports the movable blade; an opening and closing part that supports the fixed blade and has a first end connected to the body part of the printer such that the opening and closing part is allowed to open and close; an opening and closing lever provided at a second end of the opening and closing part opposite the first end, and configured to rotate between a free position for allowing the opening and closing part to open and close, and a locking position for fixing the opening and closing part to the body part; and a separating mechanism configured to separate the fixed blade from the movable blade in a separating direction in conjunction with an unlocking operation of the opening and closing lever in which the opening and closing lever is rotated from the locking position to the free position, the separating direction intersecting with an operating direction in which the movable blade moves.

According to another example of the present disclosure, a printer includes: a printing part configured to print on a recording sheet; a fixed blade and a movable blade configured to cut the recording sheet printed by the printing part; a body part that supports the movable blade; an opening and closing part that supports the fixed blade and has a first end connected to the body part such that the opening and closing part is allowed to open and close; an opening and closing lever provided at a second end of the opening and closing part opposite the first end, and configured to rotate between a free position for allowing the opening and closing part to open and close, and a locking position for fixing the opening and closing part to the body part; a cutter driving part configured to move the movable blade between a standby position where the movable blade is placed before cutting of the recording sheet begins and an end position where the cutting the recording sheet ends; a movable blade sensor configured to detect the standby position and the end position of the movable blade; and a control part configured to control the cutter driving part to bring the movable blade back to the standby position when the movable blade fails to move from the standby position and reach the end position within a predetermined period of time.

According to yet another example of the present disclosure, a printer includes: a printing part configured to print on a recording sheet; a fixed blade and a movable blade configured to cut the recording sheet printed by the printing part; a body part that supports the movable blade; an opening and closing part that supports the fixed blade and has a first end connected to the body part such that the opening and closing part is allowed to open and close; a swing support part that supports the fixed blade such that the fixed blade is allowed to swing between a cutting angle and a free angle, a distal end of the fixed blade coming into contact with the movable blade when the fixed blade is at the cutting angle, and being separated from the movable blade in the separating direction when the fixed blade is at the free angle; and an elastic support part that supports the fixed blade at the cutting angle. The fixed blade has an operating protrusion that is formed at an opposite end of the fixed blade from the distal end, and that protrudes outward with respect to the opening and closing part. The operating protrusion of the fixed blade supported by the swing support part is pushed toward the movable plate, so that the elastic support part is deformed elastically and the fixed blade swings from the cutting angle to the free angle.

According to the above examples of the present disclosure, it is possible to provide a printer in which an opening and closing part, including a fixed blade, can be opened and closed easily and reliably even when a recording sheet gets jammed, and which can separate the fixed blade from a movable blade by using a simple structure.

### BRIEF DESCRIPTION OF DRAWINGS

FIG. 1 is a perspective view of a printer according to a first embodiment;

FIG. 2 is a perspective view of a body part and an opening and closing part of the printer;

FIG. 3 is a cross-sectional view of the body part and the opening and closing part;

FIG. 4 is an enlarged perspective view of the opening and closing part;

FIG. 5 is a perspective view of an opening and closing lever of the printer;

FIG. 6 is an enlarged cross-sectional view of the opening and closing part;

FIG. 7 is a front view showing the opening and closing lever's unlocking operation;

FIG. 8 is an enlarged cross-sectional view of the printer's separating mechanism;

FIG. 9 is a block diagram of the printer's control system;

FIG. 10 is a front view (1) showing an example of the printer's movable blade sensor;

FIG. 11 is a front view (2) showing an example of the printer's movable blade;

FIG. 12 is an enlarged perspective view of the printer's open and close sensor;

FIG. 13 is a flowchart of processes performed by the printer's control device;

FIG. 14 is a perspective view showing a modification of the opening and closing lever;

FIG. 15 is a schematic front view of a printer according to a second embodiment;

FIG. 16A is a schematic front view showing a part of a printer according to a third embodiment;

FIG. 16B is an enlarged view showing the opening and closing lever's unlocking operation;

FIG. 17 is an enlarged cross-sectional view of the printer's separating mechanism;

FIG. 18 is a perspective view of a body part and an opening and closing part of a printer according to a fourth embodiment;

FIG. 19 is an enlarged cross-sectional view of the printer's fixed blade;

FIG. 20 is a perspective view of the printer's opening and closing lever; and

FIG. 21 is an enlarged view of the printer's body part and opening and closing part.

### DESCRIPTION OF EMBODIMENTS

In existing printers such as those mentioned earlier, when a recording sheet gets jammed between the fixed blade and the movable blade during use, the lever part is operated to start the conjunctional mechanism, and the contact pressure between the movable blade and the fixed blade that is causing the jamming is released. Subsequently, a lock mechanism that locks an open/close window with respect to a casing can be unlocked, allowing the open/close window to open.

However, with these existing printers, when a recording sheet gets jammed during use, the open/close window may not open even if the lock mechanism is unlocked without operating the lever part. Furthermore, the conjunctional mechanism of these printers have many parts and its structure is complex.

The present disclosure therefore aims to provide a printer in which an opening and closing part, including a fixed blade, can be opened and closed easily and reliably even when a recording sheet gets jammed, and which can separate the fixed blade from a movable blade by using a simple structure.

Hereinafter, a description will be given of embodiments of the present disclosure with reference to the accompanying drawings.

### First Embodiment

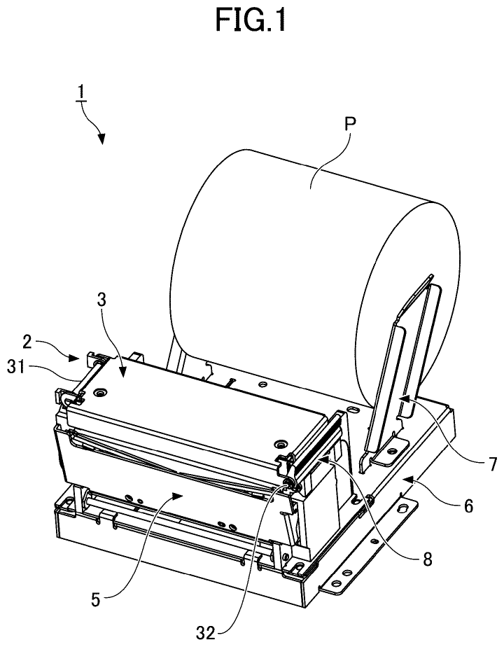

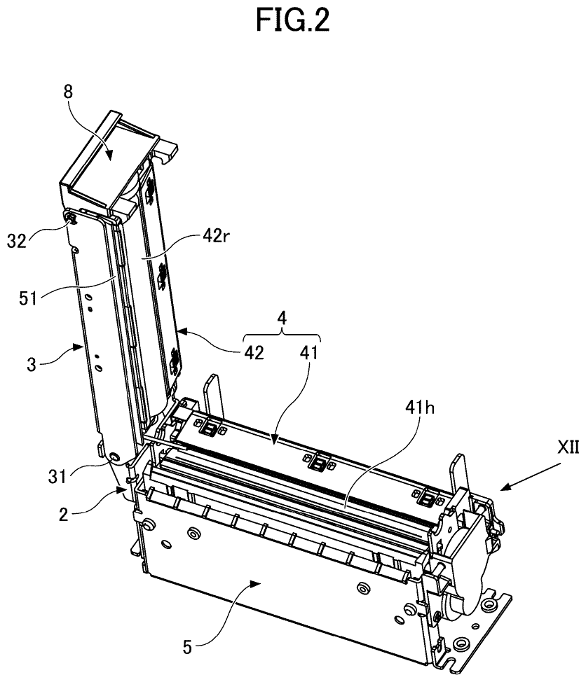

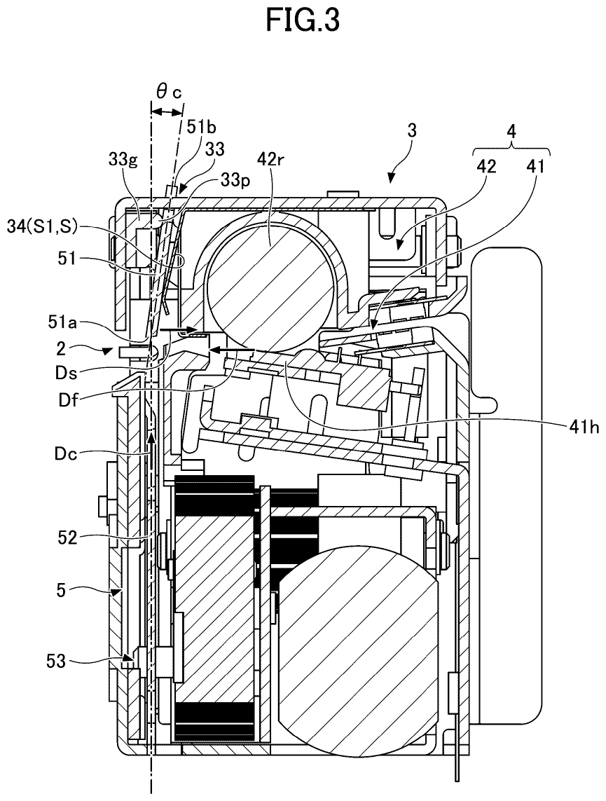

FIG. 1 is a perspective view showing a printer according to a first embodiment of the present disclosure. FIG. 2 is a perspective view of a body part 2 and an opening and closing part 3 of the printer 1 shown in FIG. 1. FIG. 3 is a cross-sectional view of the body part 2 and the opening and closing part 3 of the printer 1 shown in FIG. 1.

The printer 1 of this embodiment is, for example, a thermal printer with a thermal print head 41h, and is used, for example, in a multimedia station (MMS), an automated teller machine (ATM), a cash dispenser (CD) machine, a ticket issuing machine, a cash register, or the like, installed in a convenience store. For example, the printer 1 conveys a recording sheet P, which is thermal paper, prints information, data, numbers, and so forth on the recording sheet P, and cuts the recording sheet P into pieces, thereby outputting tickets, receipts, and so forth.

The printer 1 includes, for example, a body part 2, an opening and closing part 3, a printing part 4, a cutting part 5, a base part 6, and a recording sheet holder 7. The body part 2 is, for example, a main frame that is fixed to the base part 6, and the opening and closing part 3, the printing part 4, the cutting part 5, and the like are attached thereto.

The opening and closing part 3 is, for example, a part that can be opened and closed, located high on the side of the body part 2 where the recording sheet P is inserted. The opening and closing part 3 has, for example, a rectangular planar shape. The width direction of the recording sheet P, which is a paper roll, is the longitudinal direction of the opening and closing part 3. One longitudinal end of the opening and closing part 3 is provided with, for example, a rotating shaft 31. The rotating shaft 31 is inserted in through-holes provided in the body part 2, and, for example, the opening and closing part 3 is connected to the body part 2 via the rotating shaft 31 such that the opening and closing part 3 can be opened and closed.

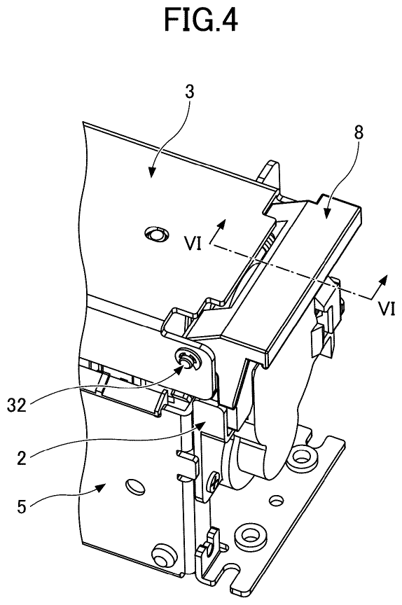

FIG. 4 is an enlarged perspective view of an end of the opening and closing part 3 of the printer 1 shown in FIG. 1. As shown in FIG. 1 and FIG. 4, an opening and closing lever 8 is provided at the end of the opening and closing part 3 that is opposite from the end connected to the body part 2. The opening and closing lever 8 is rotatably supported, for example, by a rotating shaft 32 provided in the opening and closing part 3. The opening and closing lever 8 rotates between a locking position and a free position. When the opening and closing lever 8 is placed in the locking position, the opening and closing part 3 is fixed to body part 2. When the opening and closing lever 8 is placed in the free position, the opening and closing part 3 can be opened and closed. The details will be described later. The opening and closing lever 8 also functions as a handle when the opening and closing part 3 closed as shown in FIG. 1 and FIG. 3 is opened as shown in FIG. 2.

The printing part 4 includes, for example, a head unit 41 and a platen unit 42, as shown in FIG. 2 and FIG. 3. The head unit 41 is attached, for example, to the body part 2, which is the main frame. The platen unit 42 is attached, for example, to the opening and closing part 3. The head unit 41 includes, for example, a thermal print head 41h, which is a print head. The platen unit 42 includes a platen roller 42r that transports the recording sheet P.

A transport/drive system, such as a motor and gears for allowing the platen roller 42r of the platen unit 42 to rotate, is attached, for example, to the body part 2. In the printer 1, for example, when the opening and closing part 3 is closed, a gear provided in the platen roller 42r is connected with a gear of the transport/drive system attached to the body part 2. In the printing part 4, for example, a recording sheet P is inserted between the head unit 41 and the platen unit 42 and transported in the forward direction Df by the platen roller 42r. Printing is performed on the recording sheet P by thermal print head 41h.

The cutting part 5 includes, for example: a fixed blade 51 and a movable blade 52 that cut the recording sheet P printed by the printing part 4; and a cutter driving part 53 that supports the movable blade 52 and moves it up and down. The cutter driving part 53 is, for example, constantly connected with a motor and a gear. The fixed blade 51 is positioned lengthwise with respect to the rectangular opening and closing part 3 and supported by the opening and closing part 3, as shown in FIG. 2, for example. The fixed blade 51 has an elongated shape that extends in the width direction of the recording sheet P. In other words, the longitudinal direction of the fixed blade 51 and the longitudinal direction of the opening and closing part 3 match each other.

Referring to the example shown in FIG. 3, the fixed blade 51 is supported such that it can swing via a swing support part 33 formed in the upper wall of the opening and closing part 3, for example. To be more specific, the fixed blade 51 has a protruding part 51b at the opposite end of the distal end 51a that cuts the recording sheet P. The swing support part 33 is a through-hole that is formed in the upper wall of the opening and closing part 3, for example. The swing support part 33 may have, for example, a fixed blade guide 33g that is fixed to the front wall of the opening and closing part 3. The front wall of the opening and closing part 3 faces the fixed blade 51. The fixed blade guide 33g may have, for example, a protrusion 33p that protrudes toward the fixed blade 51 and contacts the proximal end of the fixed blade 51.

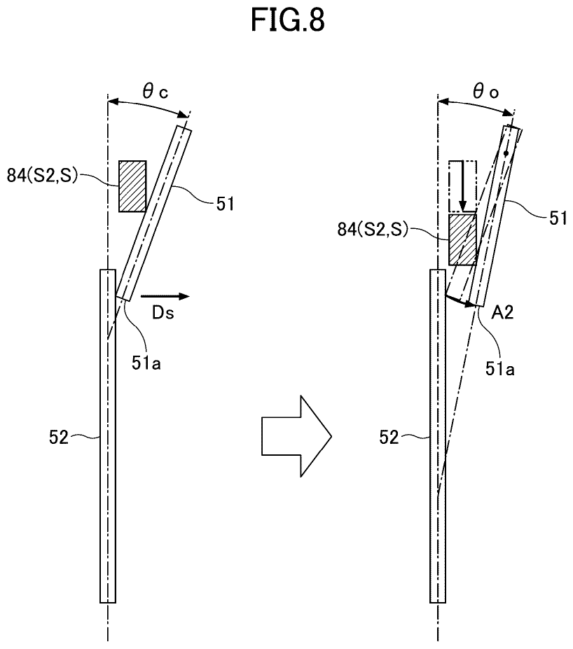

For example, the protruding part 51b of the fixed blade 51 penetrates through or is accommodated in the swing support part 33, so that the fixed blade 51 can swing in a predetermined range of angles, with the protrusion 33p of the fixed blade guide 33g serving as a fulcrum. The swing support part 33 supports the fixed blade 51 such that the fixed blade 51 can swing between, for example, a cutting angle θc and a free angle θo. A cutting angle θ refers to an angle at which the distal end 51a of the fixed blade 51 gets closer to the movable blade 52. A free angle θo refers to an angle at which the distal end 51a of the fixed blade 51 moves away from the movable blade 52 (see FIG. 8). The details will be described later.

Also, in the example shown in FIG. 3, the fixed blade 51 is supported by, for example, an elastic support part 34 and the fixed blade guide 33g, at a cutting angle θc at which the distal end 51a gets closer to the movable blade 52. The elastic support part 34 is, for example, a leaf spring that is bent at a predetermined angle. One side of the bent portion of the elastic support part 34 is fixed to the upper wall of the opening and closing part 3, for example, and the opposite side supports the fixed blade 51.

Where a force acts to separate the distal end 51a of the fixed blade 51 from the movable blade 52 in a separating direction Ds that intersects with the movable blade 52, the elastic support part 34 produces an elastic force in the opposite direction of the separating direction Ds. In other words, the elastic support part 34 functions as a preloading part S1 that preloads the fixed blade 51 in the opposite direction of the separating direction Ds. The preloading part S1 is, for example, a part of the separating mechanism S that separates the fixed blade 51 from the movable blade 52.

The movable blade 52 is supported by the body part 2 by attaching the cutting part 5 to the body part 2. The movable blade 52 is provided such that it can be moved in a cutting direction Dc by the cutter driving part 53. The cutting direction Dc refers to the direction in which the movable blade 52 moves, and is roughly perpendicular to the forward direction Df of the recording sheet P. The cutter driving part 53 includes, for example, a motor, gears, a link mechanism and so forth, attached to the body part 2, and, by running the motor, moves the movable blade 52 back and forth in the cutting direction Dc and the opposite direction. The cutter driving part 53 moves the movable blade 52, for example, between a standby position where the movable blade 52 is placed before starting cutting of the recording sheet P, and an end position where the movable blade 52 finishes cutting the recording sheet P.

As shown in FIG. 1, the base part 6 is, for example, a rectangular, plate-like member that serves as a base for the printer 1. The body part 2 and a recording sheet holder 7 are positioned side by side on the base part 6, and fixed to the base part 6. The recording sheet holder rotatably 7 supports a recording sheet P (for example, a paper roll) and continuously feeds the recording sheet P between the head unit 41 and the platen unit 42 of the printing part 4.

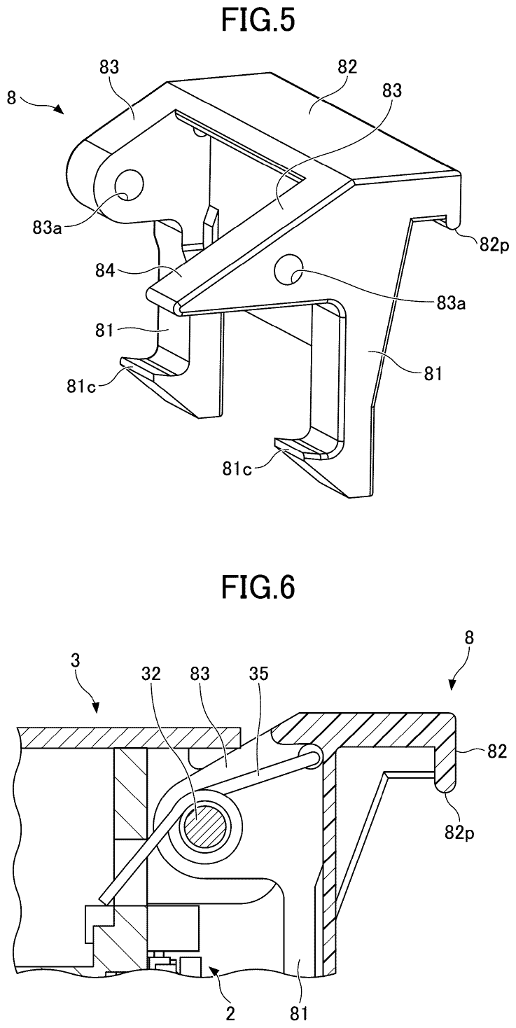

The printer 1 of this embodiment characteristically has a separating mechanism S that separates the fixed blade 51 from the movable blade 52 in the separating direction Ds that intersects with the direction in which the movable blade 52 moves, through an unlocking operation in which the opening and closing lever 8 is rotated from a locking position to a free position. The structure of the separating mechanism S in the printer 1 of this embodiment will be described in detail below with reference to FIG. 5 to FIG. 8.

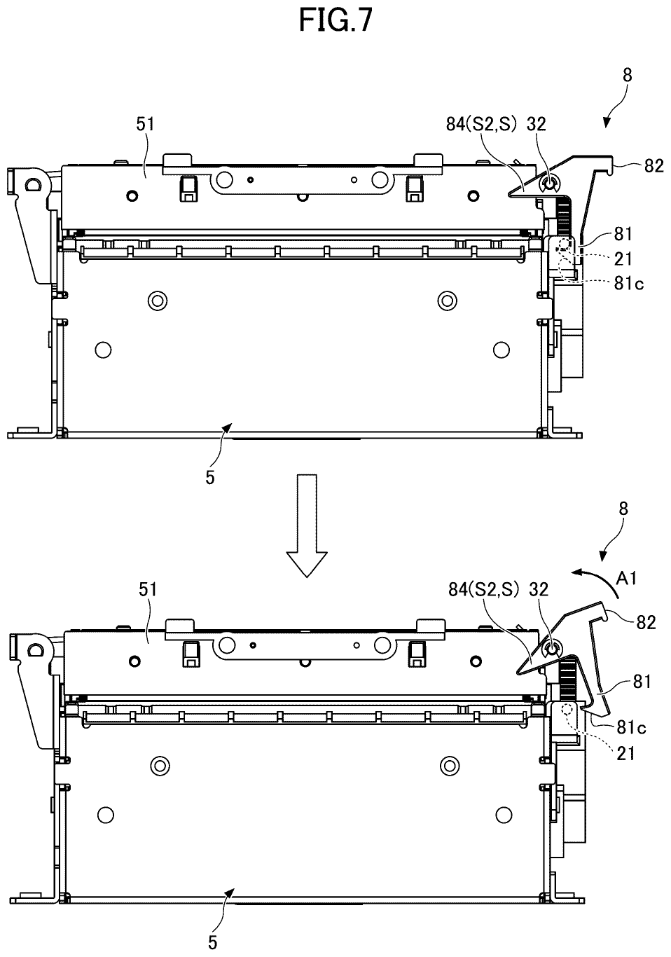

FIG. 5 is a perspective view of the opening and closing lever 8 provided in an end of the opening and closing part 3 shown in FIG. 4. FIG. 6 is an enlarged cross-sectional view of an end of the opening and closing part 3, taken along the line VI-VI in FIG. 4. FIG. 7 is a front view showing the unlocking operation of the opening and closing lever 8 of the printer 1 shown in FIG. 1. Note that, in FIG. 7, part of the structure of the opening and closing part 3 is omitted in order to make the fixed blade 51 and the movable blade 52 of the cutting part 5 visible.

Referring to FIG. 5, the opening and closing lever 8 has, for example, engaging parts 81, a holding part 82, pivotally-supported parts 83, and a protruding part 84.

The engaging parts 81 extend along the sides of the opening and closing part 3 and engage with the sides of the body part 2 when the opening and closing lever 8 is placed in the locking position as shown in the upper diagram of FIG. 7. To be more specific, the opening and closing lever 8 has, for example, a pair of engaging parts 81 provided on both sides of the opening and closing lever 8 in the longitudinal direction (which corresponds to the width direction of the opening and closing part 3). The pair of engaging parts 81 extend along the longitudinal ends of the opening and closing part 3. For example, when the opening and closing lever 8 is placed in the locking position, each engaging part 81 engages with a side of the body part 2 by hooking a claw 81c, formed in the distal end of the engaging part 81 adjoining a side of the body part 2, to the protrusion 21 formed in a side of the body part 2.

The holding part 82 is formed in the proximal end of the engaging parts 81 adjoining the opening and closing part 3, and protrudes in a direction to be away from the sides of the opening and closing part 3. The direction in which the holding part 82 protrudes is generally perpendicular to the direction in which each engaging part 81 extends from the proximal end to the distal end. At the distal end of the holding part 82 in its protruding direction, a protrusion 82p that protrudes toward the respective distal ends of the engaging parts 81 is formed, as shown in FIG. 5 and FIG. 6. Accordingly, when a worker who operates the opening and closing lever 8 lifts the holding part 82 with his/her hand, he/she can hold the holding part 82 and hook his/her fingers on the protrusion 82p.

Each pivotally-supported part 83 protrudes from the proximal end of the corresponding engaging part 81, in the opposite direction from the holding part 82, and is supported by the opening and closing part 3. To be more specific, for example, the opening and closing lever 8 has a pair of pivotally-supported parts 83 that are provided on both longitudinal sides of the opening and closing lever 8 that meet a longitudinal end of the opening and closing part 3. Each pivotally-supported part 83 has a through-hole 83a, through which the rotating shaft 32 provided in the opening and closing part 3 is inserted. The pair of pivotally-supported parts 83 are supported rotatably by the opening and closing part 3, for example, by inserting the rotating shaft 32 provided in the opening and closing part 3 in the through-holes 83a provided in both pivotally-supported parts 83.

Also, as shown in FIG. 6, a torsion spring 35 is provided at the end of the opening and closing part 3 where the opening and closing lever 8 is provided. To be more specific, the rotating shaft 32 of the opening and closing part 3 is inserted in the torsion spring 35, so that the torsion spring 35 is positioned in the vicinity of the pivotally-supported part 83. The torsion spring 35 preloads the opening and closing lever 8, which is in a free position as shown in the lower diagram of FIG. 7, in the direction for bringing the opening and closing lever 8 back to the locking position shown in the upper diagram of FIG. 7.

As shown in the upper diagrams of FIG. 5 and FIG. 7, for example, when the opening and closing lever 8 is placed in the locking position, the protruding part 84 protrudes, from the distal end of one of the pivotally-supported parts 83 adjoining the fixed blade 51, in the longitudinal direction of the fixed blade 51. In the example shown, the protruding part 84 has a wedge-like shape with a pointed tip, but the shape of the protruding part 84 is not particularly limited and can be any shape such as a rectangle, a semi-circle, a cylinder, and so forth.

In the printer 1 of this embodiment, when the opening and closing lever 8 is placed in a free position as shown in the lower diagram of FIG. 7, the protruding part 84 formed in the opening and closing lever 8 serves a push part S2 that pushes the fixed blade 51 in the separating direction Ds shown in FIG. 3. The push part S2 constitutes a separating mechanism S that separates the fixed blade 51 from the movable blade 52 in the separating direction Ds that intersects with the direction in which the movable blade 52 moves, through an unlocking operation in which the opening and closing lever 8 is rotated from a locking position to a free position.

In the printer 1 of this embodiment, the separating mechanism S includes, for example, a preloading part S1, which is constituted by the elastic support part 34 shown in FIG. 3, and a push part S2, which is the protruding part 84 formed in the opening and closing lever 8 as shown in FIG. 5. The preloading part S1 preloads the fixed blade 51 in the opposite direction from the separating direction Ds as shown in FIG. 3. The push part S2 pushes the fixed blade 51 in the separating direction Ds while the opening and closing lever 8 is placed in a free position as shown in the lower diagram of FIG. 7. The separating mechanism S may also include, for example, a swing support part 33 that supports the fixed blade 51 such that the fixed blade 51 can swing, as shown in FIG. 3.

How the separating mechanism in the printer 1 of this embodiment works will be described below in greater detail with reference to FIG. 7 and FIG. 8. FIG. 8 is a schematic enlarged cross-sectional view showing the operation of the separating mechanism S in the printer 1 shown in FIG. 1.

Referring to FIG. 1 and FIG. 3, when the opening and closing part 3 is closed with respect to the body part 2, the opening and closing lever 8 is in a locking position, in which the engaging part 81 is engaged with the protrusion 21 formed in a side part of the body part 2 by the preloaded force of the torsion spring 35, as shown in the upper diagram of FIG. 7. A user or a maintenance worker of the printer 1 who opens the opening and closing part 3 with respect to the body part 2 holds the holding part 82 of the opening and closing lever 8 and rotates the opening and closing lever 8 in the direction of the arrow A1 shown in the lower diagram of FIG. 7.

As a result of this, the claw 81c of the engaging part 81 parts from the protrusion 21 of the side of the body part 2, thus disengaging the engaging part 81 and the sides of the body part 2. Then, as shown in the lower diagram of FIG. 7, the opening and closing lever 8 rotates to the free position where the opening and closing part 3 can be opened and closed. In this way, by an unlocking operation of rotating the opening and closing lever 8 from a locking position to a free position, the protruding part 84 of the opening and closing lever 8, which is the push part S2 shown in the left diagram of FIG. 8, moves closer to the movable blade 52, as shown in the right diagram of FIG. 8.

As a result of this, the fixed blade 51, supported by the swing support part 33 at a cutting angle θc at which the recording sheet P can be cut, with respect to the movable blade 52, is pushed in a separating direction Ds so as to move away from the movable blade 52, by the protruding part 84 of the opening and closing lever 8, which is the push part S2. By this means, the elastic support part 34, which is the preloading part S1 that preloads the fixed blade 51 shown in FIG. 3 in the opposite direction of the separating direction Ds, is deformed elastically. As a result of this, the distal end 51a of the fixed blade 51, which is swingably supported by the swing support part 33, swings in the direction of the arrow A2 shown in the right diagram in FIG. 8, and a gap is formed between the movable blade 52 and the fixed blade 51. As described above, in the printer 1 of this

embodiment, the separating mechanism S includes the elastic support part 34, which serves as the preloading part S1, and the protruding part 84 of the opening and closing lever 8, which serves as the push part S2. Thus, the separating mechanism S of the printer 1 of this embodiment can separate the fixed blade 51 from the movable blade 52 in the separating direction Ds that intersects with the cutting direction Dc, which is the direction in which the movable blade 52 moves, through an unlocking operation in which the opening and closing lever 8 is rotated from a locking position to a free position.

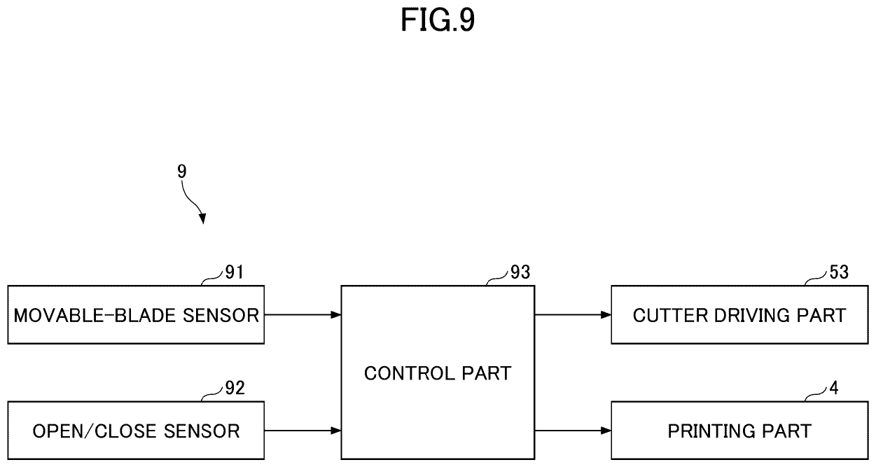

Next, with reference to FIG. 9 to FIG. 12, a method of reducing or substantially reducing the jamming of recording sheets by the control system of the printer 1 of this embodiment will be described. FIG. 9 is a block diagram showing a

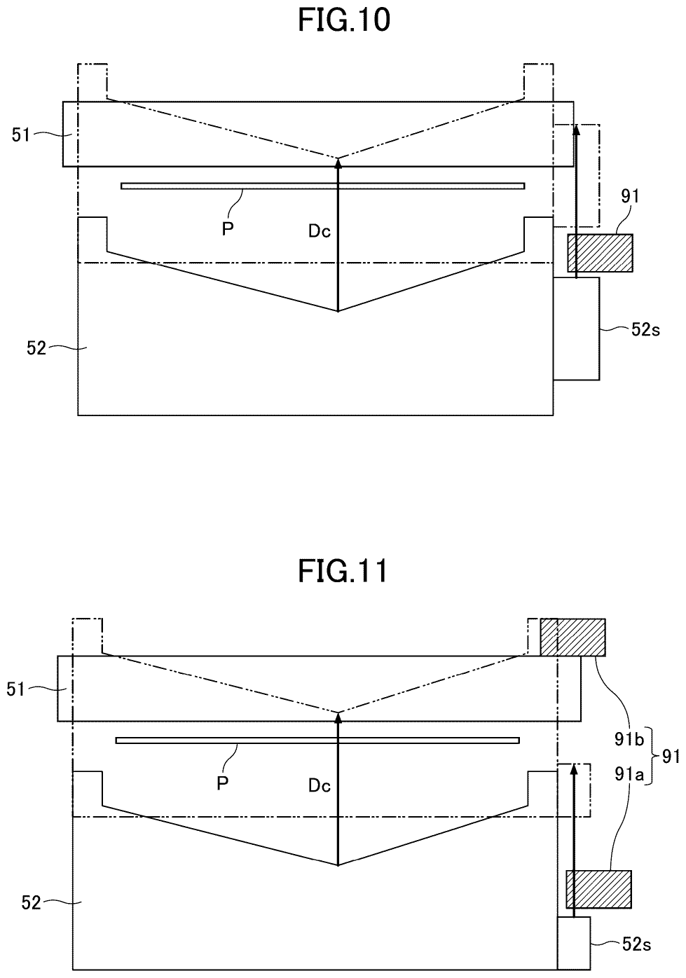

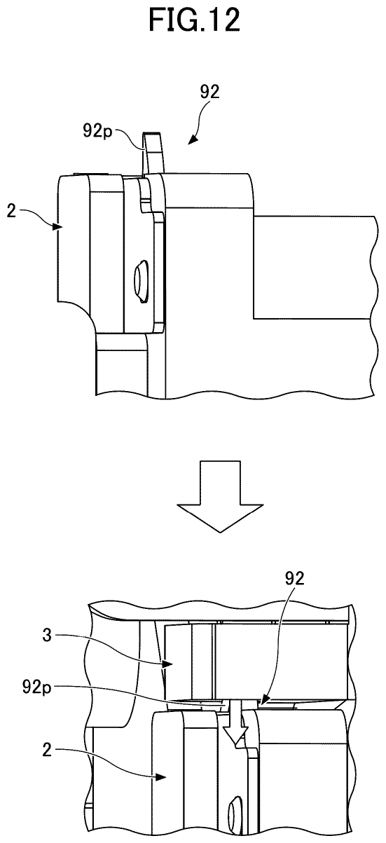

schematic structure of the control system 9 of the printer 1 shown in FIG. 1. FIG. 10 is a schematic front view showing an example of the movable blade sensor 91 shown in FIG. 9. FIG. 11 is a schematic front view showing another example of the movable blade sensor 91 shown in FIG. 9. FIG. 12 is an enlarged perspective view taken in the direction of the arrow XII in FIG. 2, showing an example of the open and close sensor 92 shown in FIG. 9.

The printer 1 of this embodiment is equipped with a control system 9 including a movable blade sensor 91, an open and close sensor 92, and a control part 93, as shown in FIG. 9, for example.

Referring to the examples shown in FIG. 10 and FIG. 11, the movable blade sensor 91 is a sensor that detects a block part 52s provided in the movable blade 52. The block part 52s is formed, for example, to protrude outward with respect to one end of the movable blade 52 in the width direction, which is aligned with the width direction of the recording sheet P. The movable blade sensor 91 can be any sensor that can detect the block part 52s, such as a photoelectric sensor, a fiber sensor, a laser sensor, a proximity sensor, or an eddy current sensor.

In the example shown in FIG. 10, at one end of the width of the movable blade 52, the block part 52s is formed in the middle between the distal end where the tooth of the movable blade 52 is formed, and the opposite end, not including the proximal end. In this case, the movable blade sensor 91 is positioned so as to adjoin the block part 52s of the movable blade 52 in the standby position, with respect to the direction in which the movable blade 52 moves. The position of the movable blade sensor 91 shown in FIG. 10 is where the block part 52s passes the movable blade sensor 91 when the movable blade 52 moves in the cutting direction Dc, toward the end position where the cutting of the recording sheet P is completed.

In the example shown in FIG. 10, the movable blade sensor 91 starts detecting the block part 52s when the movable blade 52 starts moving from the standby position, in the cutting direction Dc, and stops detecting the block part 52s when the movable blade 52 reaches the end position. The control part 93 can determine that the movable blade 52 has moved from the standby position to the end position by obtaining the detection results of the block part 52s from the movable blade sensor 91.

In the example shown in FIG. 11, the block part 52s is provided at one end of the movable blade 52 in the width direction, in the proximal end that is opposite from the distal end where the tooth of the movable blade 52 is formed. In this case, the movable blade sensor 91 includes: a first sensor 91a positioned to adjoin the block part 52s of the movable blade 52 in the standby position, with respect to the direction in which the movable blade 52 moves, and a second sensor 91b positioned to face the upper end of the movable blade 52 in the end position.

In the example shown in FIG. 11, the first sensor 91a of the movable blade sensor 91 starts detecting the block part 52s when the movable blade 52 starts moving from the standby position in the cutting direction Dc. Also, the second sensor 91b of the movable blade sensor 91 detects the movable blade 52 when the movable blade 52 reaches the end position. By obtaining the detection results of the block part 52s and the movable blade 52 from the first sensor 91a and the second sensor 91b of the movable blade sensor 91, the control part 93 can determine that the movable blade 52 has moved from the standby position to the end position.

The open and close sensor 92 is a sensor that detects, for example, an open state of the opening and closing part 3, in which the opening and closing part 3 is open with respect to the body part 2 as shown in FIG. 2, and a closed state of the opening and closing part 3, in which the opening and closing part 3 is closed with respect to the body part 2 as shown in FIG. 1. In the example shown in the upper diagram of FIG. 12, the open and close sensor 92 is, for example, a detection switch attached to the end of the body part 2 that is opposite from the end of the body part 2 where the opening and closing part 3 of is connected, and includes a plunger 92p and a contact that is not shown.

For example, as shown in the upper diagram of FIG. 12, when the opening and closing part 3 is open, the plunger 92p is preloaded by a spring and protrudes from the upper surface of the body part 2. The upper surface of the body part 2 faces the opening and closing part 3. In this state, the contact of the open and close sensor 92 is closed. Also, when the opening and closing part 3 is closed, the plunger 92p is pushed by the lower surface of the opening and closing part 3 facing the body part 2, in the opposite direction of the protruding direction, as shown in the lower diagram of FIG. 12, for example. In this state, the contact of the open and close sensor 92 is open.

That is, the open and close sensor 92 is, for example, a normally-closed-type detection switch. The contact opens and the open and close sensor 92 is switched off when the opening and closing part 3 is closed. The contacts is closed and the open and close sensor 92 is switched on when the opening and closing part 3 is open. Note that the open and close sensor 92 may be, for example, a normally-open-type detection switch or a different sensor. The control part 93 can detect whether the opening and closing part 3 is open or closed, for example, based on information indicating “ON” or “OFF,” acquired from the open and close sensor 92.

The control part 93 is composed of hardware a such as microcontroller including a central processing unit (CPU), a memory such as a ROM or a RAM, a timer, and an input/output unit, and software such as programs stored in the memory. The control part 93 implements various functions of the printer 1, including control over the printing part 4 and the cutter driving part 53, by, for example, executing programs stored in the memory using the CPU.

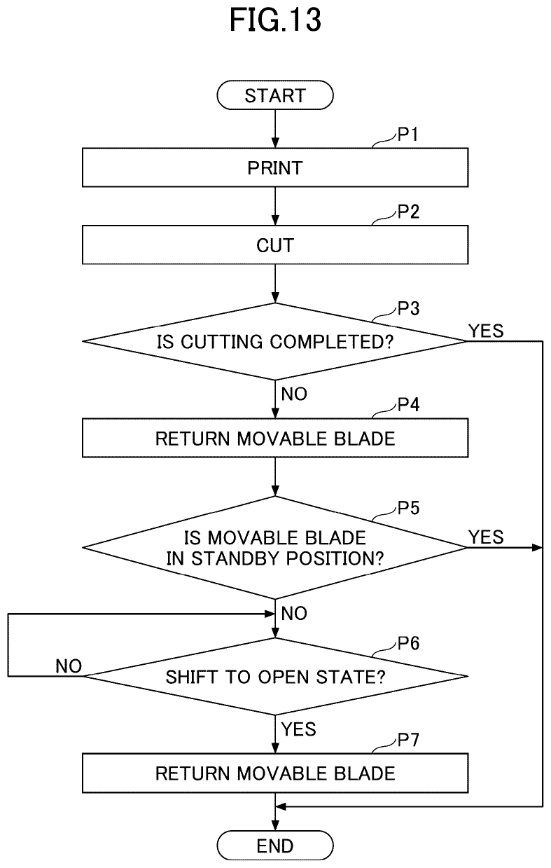

Next, the operation of the printer 1 of this embodiment will be described with reference to FIG. 13. FIG. 13 is a flowchart showing an example flow of processes that the control part 93 shown in FIG. 9 performs.

When the printer 1 starts the process flow shown in FIG. 13, for example, the printer 1 executes a process P1 to print on a recording sheet P. In this process P1, the control part 93, for example, operates a motor for driving the printing part 4 to rotate the platen roller 42r of the platen unit 42. By this means, the recording sheet P, which is unrolled from the paper roll held by the recording sheet holder 7 and fed between the head unit 41 and the platen unit 42, is transported by the platen roller 42r. Also, in this process P1, the control part 93, for example, controls thermal print head 41h of the head unit 41 to print on the recording sheet P.

Next, the printer 1 executes, for example, a process P2 of cutting the recording sheet P. In this process P2, the control part 93, for example, controls the cutter driving part 53 to start the motor for driving the movable blade 52, moves the movable blade 52 from the standby position in the cutting direction Dc to cut the recording sheet P, and moves the movable blade 52 in the opposite direction of the cutting direction Dc, back to its standby position. When this takes place, the control part 93 may, for example, cut the recording sheet P completely, or cut the recording sheet P partially leaving a center portion of the recording sheet P uncut.

Next, the printer 1 executes, for example, a process P3 of determining whether or not the cutting of the recording sheet P is completed. In this process P3, the control part 93 determines whether or not the cutting of the recording sheet P is completed, for example, based on whether the movable blade 52 has moved from the standby position to the end position within a predetermined period of time. To be more specific, the control part 93 measures the time that has elapsed from the point in time at which the movable blade 52 started moving from the standby position, for example, based on a detection result from the movable blade sensor 91.

Also, the control part 93, for example, compares the measured elapsed time against a predetermined period of time, and determines that the cutting is completed (“YES”) if the movable blade 52 has moved to the end position before the predetermined period of time elapsed. Note that the control part 93 may determine that the cutting is completed (“YES”) if, for example, the movable blade 52 has moved from the standby position to the end position and then returned to the standby position. In this process P3, if the control part 93 determines that the cutting is completed (“YES”), the process flow of FIG. 13 is terminated.

On the other hand, a situation might arise in which the motor that drives the cutting part 5 is unable to produce a enough driving force to cut the recording sheet P between the fixed blade 51 and the movable blade 52, the recording sheet P is folded and overlaps due to a paper jam, and so forth. In this case, in the process P2 in which the recording sheet P is cut, the movable blade 52 cannot reach the end position even after a predetermined period of time has elapsed since the movable blade 52 started moving from the standby position.

In this case, in the process P3 of determining whether or not the cutting of the recording sheet P is completed, the control part 93 determines that the cutting of the recording sheet P is not completed (“NO”) when a predetermined period of time elapses before the movable blade 52 arrives at the end position. Subsequently, the control part 93 executes a process P4 of returning the movable blade 52, for example.

In this process P4, the control part 93 controls the cutter driving part 53, for example, to bring the movable blade 52, which has stopped between the standby position and the end position, back to the standby position. Subsequently, the control part 93 executes a process P5 of determining whether or not the fixed blade 51 has returned to its standby position.

For example, assuming that the recording sheet P is not jammed between the fixed blade 51 and the movable blade 52, in the process P4, the movable blade 52 can be brought back to the standby position by the driving force of the motor for driving the cutting part 5. In this case, since the movable blade 52 can be brought back to the standby position within a predetermined period of time, in the process P5, the control part 93 determines that the movable blade 52 has returned to the standby position (“YES”) based on the detection results of the movable blade sensor 91, and ends the process flow of FIG. 13. By this means, the movable blade 52 can be brought back to the standby position before the recording sheet P gets jammed.

Subsequently, the user of the printer 1 unlocks the opening and closing lever 8 as shown in FIG. 7 to allow the opening and closing part 3 to open and close, and then lifts the opening and closing lever 8. By this means, the opening and closing part 3 is shifted from the closed state shown in FIG. 1 to the open state shown in FIG. 2, and the recording sheet P that was not cut successfully can be removed. When this takes place, the movable blade 52 has resumed its standby position, so that the safety of the user is ensured.

On the other hand, there are cases where the driving force of the motor for driving the cutting part 5 is not enough to bring the movable blade 52 back to its standby position, for example, when the recording sheet P gets caught between the fixed blade 51 and the movable blade 52.

In the printer 1 of this embodiment, the motor and gears of the cutter driving part 53 that moves the movable blade 52 in the cutting direction Dc, which is the operating direction, are constantly connected. Consequently, the issue is how to ensure a self-back function to return the movable blade 52 to the standby position when the movable blade 52 is unable to operate.

In the printer 1 of this embodiment, for example, if the movable blade 52 is unable to operate due to the recording sheet P being jammed, the movable blade 52 cannot be brought back to its standby position within a predetermined period of time. Consequently, in the process P5 shown in FIG. 13, the control part 93 determines that the movable blade 52 has not returned to the standby position (“NO”) based on a detection result from the movable blade sensor 91.

In this case, the control part 93 executes, for example, a process P6, in which whether or not the opening and closing part 3 has shifted from the closed state to the open state. In this process P6, the control part 93, for example, displays information for prompting the user to open the opening and closing part 3, on a display device connected to the printer 1, and acquires the detection result from the open and close sensor 92. In this process P6, if the control part 93 determines that the opening and closing part 3 has not shifted to the open state (“NO”) based on the detection result from the open and close sensor 92, for example, the control part 93 repeats executing the process P6 in a predetermined cycle.

If the user of the printer 1 or the like unlocks the opening and closing lever 8 shown in FIG. 7, the overlap between the fixed blade 51 and the movable blade 52 is reduced, and the portion of the recording sheet P that gets jammed between the fixed blade 51 and the movable blade 52 gets smaller. As a result of this, the user of the printer 1 or the like can lift up the holding part 82 of the opening and closing lever 8 and open the open opening and closing part 3.

When the opening and closing part 3 opens, a signal indicating that the opening and closing part 3 has shifted from the closed state to the open state is input from the open and close sensor 92 to the control part 93. Then, in the process P6 shown in FIG. 13, the control part 93 determines that the opening and closing part 3 has shifted from the closed state to the open state (“YES”), and executes a process P7 to bring back the movable blade 52 to its standby position.

By the time the process P7 is performed, the opening and closing part 3 has been opened and the jamming of the recording sheet P between the fixed blade 51 and the movable blade 52 has been reduced. Consequently, the control part 93 can control the cutter driving part 53 to bring the movable blade 52 back to the standby position by the driving force of the motor for driving the cutting part 5. Subsequently, the control part 93 ends the process flow of FIG. 13.

As described above, the printer 1 of this embodiment includes: a printing part 4 that prints on a recording sheet P; a fixed blade 51 and a movable blade 52 that cut the recording sheet P printed by the printing part 4; a body part 2 that supports the movable blade 52; and an opening and closing part 3 that supports the fixed blade 51 and is connected to the body part 2 such that the opening and closing part 3 can be opened and closed. The printer 1 also includes an opening and closing lever 8 that is provided at the end of the opening and closing part 3 that is opposite from the end of the opening and closing part 3 connected to the body part 2, and that rotates between a free position where the opening and closing part 3 can be opened and closed, and a locking position where the opening and closing part 3 is fixed to the body part 2. Furthermore, the printer 1 is equipped with a separating mechanism S that separates the fixed blade 51 from the movable blade 52 in a separating direction Ds intersects with the direction in which the movable blade 52 moves, in conjunction with an unlocking operation, in which the opening and closing lever 8 is rotated from the locking position to the free position.

Given this structure, even if a situation arises in which the movable blade 52 cannot be moved or the opening and closing part 3 cannot be opened because, for example, the recording sheet P gets jammed, the printer 1 can easily and reliably open the opening and closing part 3 simply by unlocking the opening and closing lever 8. To be more specific, when the recording sheet P gets caught between the fixed blade 51 and the movable blade 52, as shown in FIG. 7, an unlocking operation of rotating the opening and closing lever 8 from a locking position to a free position is performed. Then, as shown in FIG. 8, in conjunction with the unlocking operation of the opening and closing lever 8, the separating mechanism S separates the fixed blade 51 from the movable blade 52 in the separating direction Ds that intersects with the direction in which the movable blade 52 moves. By this means, the recording sheet P is prevented or substantially prevented from getting caught between the fixed blade 51 and the movable blade 52, so that the opening and closing part 3 can be opened easily and reliably by simply lifting up the opening and closing 8 having been rotated to the free position.

Also, according to the printer 1 of this embodiment, one end of the opening and closing part 3 in the longitudinal direction of the fixed blade 51 is connected to the body part 2, and the opening and closing lever 8 is provided at the other end of the fixed blade 51 in the longitudinal direction.

This structure allows the printer 1 to position the portion of the opening and closing part 3 connected to the body part 2 and the opening and closing lever 8 for opening and closing the opening and closing part 3 at one end and the other end of the opening and closing part 3, respectively, in a direction perpendicular to the forward direction Df of the recording sheet P. As a result of this, as shown in FIG. 1 and FIG. 3, it is possible to reduce the increase in the dimensions of the body part 2 and the opening and closing part 3 in the forward direction Df of the recording sheet P, thereby improving the versatility of the printer 1 when used in MMSs, ATMs, CDs, ticket machines, cash registers, and so on.

Also, according to the printer 1 of this embodiment, the separating mechanism S includes a preloading part S1 that preloads the fixed blade 51 in the opposite direction of the separating direction Ds, and a push part S2 that pushes the fixed blade 51 in the separating direction Ds when the opening and closing lever 8 is in a free position.

Assuming that the opening and closing lever 8 is placed in the locking position as shown in the upper diagram of FIG. 7, this structure allows the printer 1 to support the fixed blade 51 at a cutting angle θc by preloading the fixed blade 51 in the opposite direction of the separating direction Ds, using the preloading part S1, as shown in the left diagrams of FIG. 3 and FIG. 8. Also, while the opening and closing lever 8 is placed in the free position as shown in the lower diagram of FIG. 7, the printer 1 can rotate the push part S2 in conjunction with the unlocking operation of the opening and closing lever 8, as shown in the right diagram of FIG. 8, and push the fixed blade 51 in the separating direction Ds by means of the push part S2. When this takes place, the printer 1 can, for example, preload the fixed blade 51 in the opposite direction of the separating direction Ds by means of the preloading part S1 and support the fixed blade 51 at a free angle θo, which is smaller than the cutting angle θc, so that a gap is formed between the distal end 51a of the fixed blade 51 and the movable blade 52.

Also, according to the printer 1 of this embodiment, the push part S2 is a protruding part 84 formed in the opening and closing lever 8.

The above-described structure allows the printer 1 to have a more simply structured separating mechanism S, without the need to use a large number of parts such as the conjunctional mechanism of existing printers such as the ones described earlier. Also, the fixed blade 51 can be separated from the movable blade 52 by the unlocking operation of the opening and closing lever 8 alone, in which the opening and closing part 3 being fixed to the body part 2 is disengaged.

Also, according to the printer 1 of this embodiment, the opening and closing lever 8 has engaging parts 81 that extend along the sides of the opening and closing part 3 placed in the locking position and engage with the sides of the body part 2, and a holding part 82 that is formed in the proximal end of the engaging parts 81 adjoining the opening and closing part 3 and that protrudes in a direction to move away from the sides of the opening and closing part 3.

This structure allows, for example, the user of the printer 1 to hold and lift up the holding part 82 of the opening and closing lever 8 in the locking position, thereby allowing the opening and closing lever 8 to be rotated from the locking position to the free position and disengaging the sides of the body part 2 and the engaging part 81. Also, the user of the printer 1 can close the opening and closing part 3 with respect to the body part 2, and then release the holding part 82 or push the holding part 82 downward to make the opening and closing lever 8 rotate from the free position to the locking position, thereby making the sides of the body part 2 and the engaging part 81 engage with each other.

Furthermore, as shown in FIG. 9, the printer 1 of this embodiment includes a cutter driving part 53, a movable blade sensor 91, and a control part 93. As shown in FIG. 10 and FIG. 11, the cutter driving part 53 operates the movable blade 52 between a standby position where the movable blade 52 is placed before the cutting of the recording sheet P begins and an end position where the cutting of the recording sheet P ends. The movable blade sensor 91 is configured to detect the standby position and the end position of the movable blade 52. As shown in the process P3 and the process P4 of FIG. 13, when the movable blade 52 moves from the standby position and fails to reach the end position within a predetermined period of time according to a detection result from the movable blade sensor 91, the control part 93 controls the cutter driving part 53 to bring the movable blade 52 back to the standby position.

This structure allows the printer 1 to bring the movable blade 52 back to the standby position when, for example, a paper jam occurs, the recording sheets P is folded, overlaps, and therefore cannot be cut between the fixed blade 51 and the movable blade 52. By this means, when the user of the printer 1 opens the opening and closing part 3 to remove the recording sheet P, the distal end of the movable blade 52 is prevented from being exposed from the body part 2, ensuring the safety of the user.

Also, as shown in FIG. 9, the printer 1 of this embodiment further includes an open and close sensor 92 that detects whether the opening and closing part 3 is open or closed. Also, the control part 93 acquires detection results from the movable blade sensor 91 and the open and close sensor 92, as shown in the process P5 and the process P6 of FIG. 13. Then, based on these detection results, if the movable blade 52 is not in the standby position while the opening and closing part 3 is closed and the opening and closing part 3 shifts from the closed state to the open state, the control part 93 controls the cutter driving part 53 to bring the movable blade 52 back to its standby position, as shown in the process P7.

Given this structure, for example, when the user or the like unlocks the opening and closing lever 8, the recording sheet P caught between fixed blade 51 and movable blade 52 can be removed, so that, when the opening and closing part 3 shifts from the closed state to the open state, the printer 1 can bring back the movable blade 52 to the standby position. By this means, when the user of the printer 1 or the like unlocks the opening and closing lever 8 and then lifts the opening and closing lever 8 to open the opening and closing part 3 and remove the recording sheet P, the distal end of movable blade 52 is prevented from being exposed from body part 2, ensuring the safety of the user or the like.

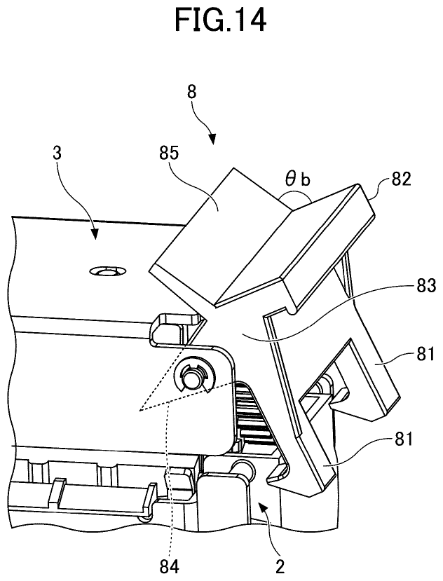

As has been described above, according to this embodiment, it is possible to provide a printer 1 in which the opening and closing part 3 can be opened and closed easily and reliably even when the recording sheet P gets jammed. Note that the printer according to the present disclosure is not limited to the structure of the printer 1 described in the first embodiment. Now, a modification of the printer 1 of the first embodiment will be described below with reference to FIG. 14.

FIG. 14 is a perspective view showing a modification of the opening and closing lever 8 shown in FIG. 5. The opening and closing lever 8 of the printer 1 according to this modification includes engaging parts 81, a holding part 82, pivotally-supported parts 83, and a protruding part 84, which are the same or substantially the same as those of the opening and closing lever 8 of the printer 1 of the first embodiment shown in FIG. 5, and additionally has a secondary protrusion 85. As described hereinabove, the engaging parts 81 extend along the sides of the opening and closing part 3 placed in the locking position and engage with the sides of the body part 2. The holding part 82 is formed in the proximal end of the engaging parts 81 adjoining the opening and closing part 3 and protrudes in a direction to be away from the sides of the opening and closing part 3. As shown in FIG. 14, the secondary protrusion 85 is provided at the proximal end of the engaging parts 81 and protrudes in the opposite direction from the distal end of the engaging part 81 such that an obtuse angle θb is formed between the holding part 82 and the secondary protrusion 85.

This structure allows the user of the printer 1 or the like to hold and lift up the holding part 82 when performing the unlocking operation of rotating the opening and closing lever 8 from the locking position to the free position. Furthermore, while holding and lifting the holding part 82, the user can apply force to the secondary protrusion 85, with his/her hand holding the holding part 82, to assist the unlocking operation of the opening and closing lever 8. Consequently, according to the modification of the printer 1 shown in FIG. 14, the opening and closing lever 8 can be rotated with more ease in the unlocking operation, in which the opening and closing lever 8 is rotated from the locking position to the free position.

### Second Embodiment

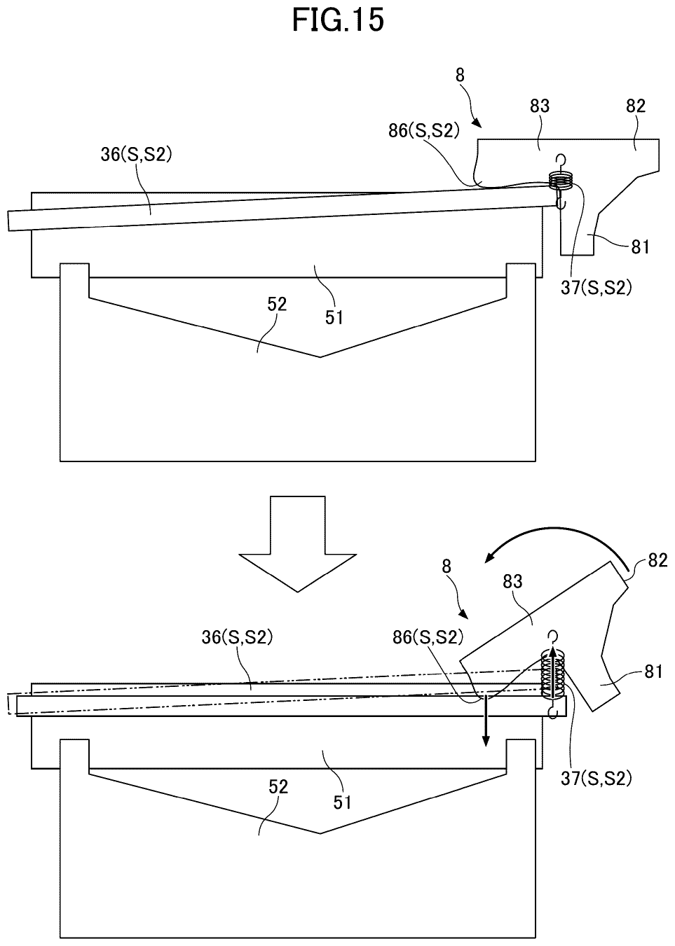

Next, a second embodiment of the printer according to the present disclosure will be described with reference to FIG. 15. FIG. 15 is a schematic front view showing a second embodiment of the printer according to the present disclosure. Note that the upper diagram of FIG. 15 shows the state before the fixed blade 51 is separated from the movable blade 52, and the lower diagram of FIG. 15 shows the state after the fixed blade 51 is separated from the movable blade 52.

The printer 1 of this embodiment is different from the printer 1 of the above-described first embodiment in the structure of the push part S2, which is part of the separating mechanism S that separates the fixed blade 51 from the movable blade 52. The rest of the structure of the printer 1 of this embodiment is the same or substantially the same as the structure of the printer 1 of the first embodiment, and therefore will be assigned the same similar reference or numerals without further description.

In this embodiment, the push part S2 constituting the separating mechanism S of the printer 1 includes, for example, a push shaft 36 positioned lengthwise with respect to the fixed blade 51 and a shaft-push part 86 provided in the opening and closing lever 8, as shown in FIG. 15. The push part S2 may also include, for example, a spring 37.

The push shaft 36 is, for example, a round, bar-shaped member made of metal or resin. The push shaft 36 is, for example, located downstream of the fixed blade 51 in the forward direction Df of the recording sheet P, and faces the front of the fixed blade 51 (the surface on the movable blade 52 side). One end of the push shaft 36 is supported, for example, by an end of the opening and closing part 3 that is connected to the body part 2, and the other end of the push shaft 36 is supported by the spring 37 that is attached to the end of the opening and closing part 3 where the opening and closing lever 8 is provided. The push shaft 36 is supported, for example, by the opening and closing part 3 such that the push shaft 36 can move between the non-push position shown in the upper diagram of FIG. 15 and the push position shown in the lower diagram of FIG. 15.

To be more specific, one end of the push shaft 36 is supported, for example, by a long hole or a universal joint that is provided in one end of the opening and closing part 3 connected to the body part 2 of the printer 1. Also, the other end of the push shaft 36 is supported, for example, by the spring 37 or a long hole that is provided in the end of the opening and closing part 3 where the opening and closing lever 8 is attached. By this means, the push shaft 36 is supported such that the push shaft 36 can be moved between the push position and the non-push position. In the push position, the fixed blade 51 is pushed in the separating direction Ds, as shown in the lower diagram of FIG. 15. The non-push position adjoins the fixed blade 51 at the cutting position where the recording sheet P can be cut, as shown in the upper diagram of FIG. 15.

As shown in the upper diagram of FIG. 15, for example, the shaft-push part 86 of the opening and closing lever 8 is provided to protrude in the opposite direction of the protruding direction of the holding part 82 that intersects with the direction in which the engaging parts 81 extend, and is positioned to adjoin the push shaft 36 that is in the non-push position when the opening and closing lever 8 is placed in the locking position. By this means, the shaft-push part 86 pushes the push shaft 36 in an unlocking operation in which the opening and closing lever 8 is rotated from the locking position shown in the upper diagram of FIG. 15 to the free position shown in the lower diagram of FIG. 15. The spring 37 stretches and is deformed elastically, thereby moving the push shaft 36 from the non-push position to the push position.

Also, when the user or the like releases his/her hand from the opening and closing lever 8, the preloaded force of the torsion spring 35 shown in FIG. 6 causes the opening and closing lever 8 to return from the free position shown in the lower diagram of FIG. 15 to the locking position shown in the upper diagram of FIG. 15. When this takes place, the preloaded force of the stretched and elastically deformed spring 37 acts on the push shaft 36 when it returns to its original position, causing the push shaft 36 to return from the push position shown in the lower diagram of FIG. 15 to the non-push position shown in the upper diagram of FIG. 15.

As described above, in the printer 1 of this embodiment, the push part S2 constituting the separating mechanism S includes the push shaft 36 that is positioned lengthwise with respect to the fixed blade 51 and the shaft-push part 86 that is provided in the opening and closing lever 8. Also, the push shaft 36 is provided such that it can move between a push position at which the push shaft 36 pushes the fixed blade 51 in the separating direction Ds, and a non-push position which adjoins the movable blade 52 placed in the cutting position where the recording sheet P can be cut. The shaft-push part 86 of the opening and closing lever 8 moves the push shaft 36 from the non-push position to the push position through the unlocking operation of the opening and closing lever 8, for example, like the protruding part 84 of the opening and closing lever 8 shown in FIG. 8.

Structured thus, the printer 1 of this embodiment can bring about the same advantages as those of the printer 1 of the first embodiment described above. To be more specific, when a recording sheet P gets jammed between the fixed blade 51 and the movable blade 52, as shown in FIG. 15, an unlocking operation is performed in which the opening and closing lever 8 is rotated from the locking position to the free position. Then, as shown in the lower diagram of FIG. 15, in conjunction with the unlocking operation of the opening and closing lever 8, the shaft-push part 86 pushes the push shaft 36 toward the movable blade 52, and the push shaft 36 pushes the fixed blade 51 in the separating direction Ds, as does the protruding part 84 of the opening and closing lever 8 shown in FIG. 8. As a result of this, the fixed blade 51 is moved away from the movable blade 52 in the separating direction Ds. By this means, the jamming of the recording sheet P between the fixed blade 51 and the movable blade 52 is cleared, and the opening and closing part 3 can be opened easily and reliably by simply lifting up the opening and closing lever 8 having been rotated to the free position.

Consequently, according to this embodiment, as in the first embodiment described above, it is possible to provide a printer 1 in which the opening and closing part 3 can be opened and closed easily and reliably even when the recording sheet P gets jammed.

### Third Embodiment

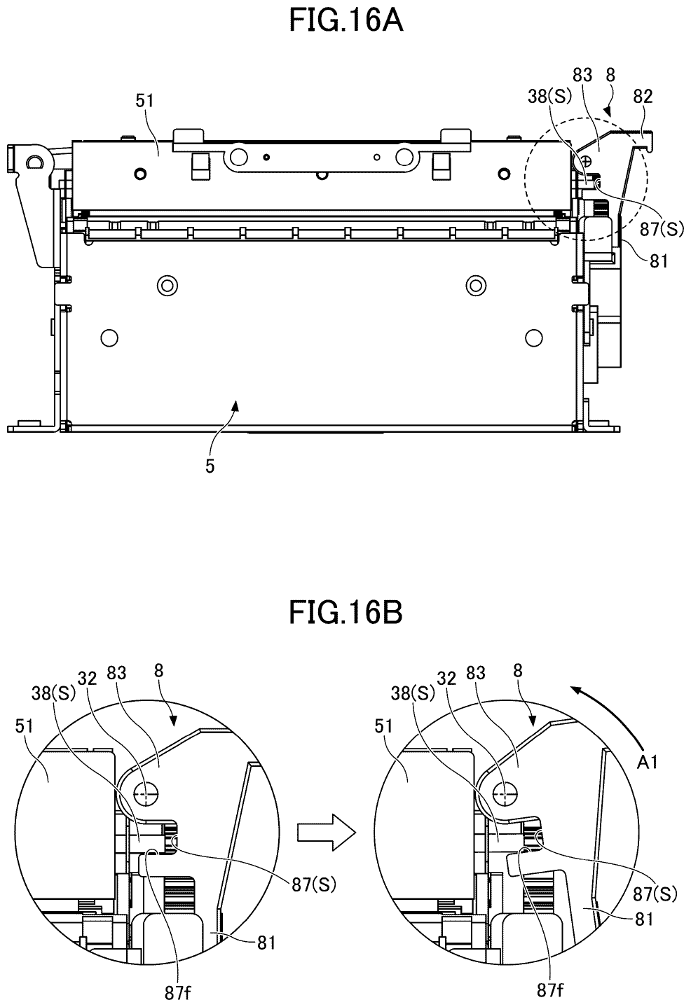

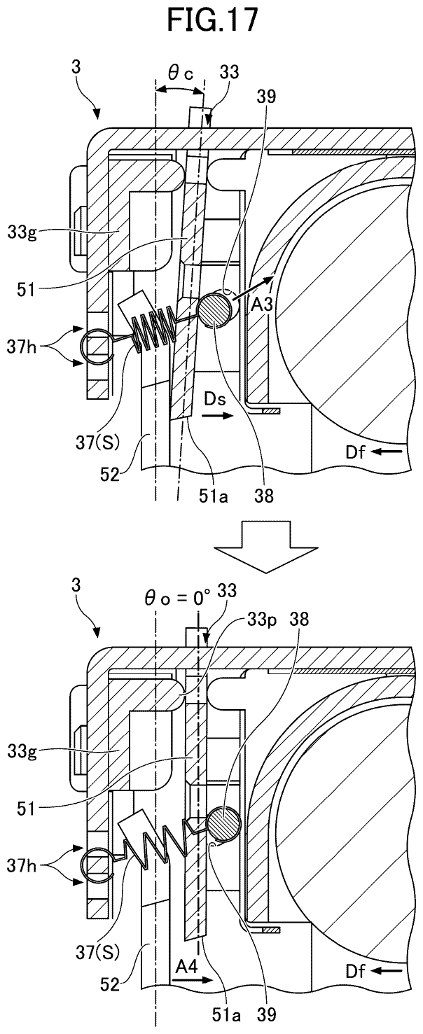

Next, a printer according to a third embodiment of the present disclosure will be described with reference to FIG. 16A, FIG. 16B, and FIG. 17. FIG. 16A is a schematic front view showing a part of the printer according to the third embodiment of the present disclosure. FIG. 16B is an enlarged view showing the unlocking operation of the opening and closing lever 8 in the printer 1 of FIG. 16A. FIG. 17 is a schematic enlarged cross-sectional view for explaining the operation of the separating mechanism S in the printer 1 of FIG. 16A. Note that the left view of FIG. 16B and the upper diagram of FIG. 17 show the state before the fixed blade 51 is separated from the movable blade 52, and the right view of FIG. 16B and the lower diagram of FIG. 17 show the state after the fixed blade 51 is separated from the movable blade 52.

The printer 1 of this embodiment is different from the printer 1 of the first embodiment and the second embodiment described above in the structure of the separating mechanism S for separating the fixed blade 51 from the movable blade 52. The rest of the structure of the printer 1 of this embodiment is the same or substantially the same as the structure of the printer 1 of the first embodiment described above, and so such parts will be assigned the same or substantially the same reference numerals and description thereof will be omitted.

In this embodiment, the separating mechanism S of the printer 1 includes, for example, the swing support part 33 shown in FIG. 17. As shown in FIG. 17, the swing support part 33 supports the movable blade 52 such that the movable blade 52 can swing between a cutting angle θc and a free angle θo. At the cutting angle θc, the distal end 51a of the fixed blade 51 gets closer to the movable blade 52. At the free angle θo, the distal end 51a of the fixed blade 51 moves away from the movable blade 52 in the cutting direction Dc. Note that, in the example shown in the lower diagram of FIG. 17, the fixed blade 51 and the movable blade 52 are approximately parallel, and the free angle θo is approximately equal to 0 degrees.

Also, in this embodiment, the separating mechanism S of the printer 1 includes, for example, a support shaft 38, and a shaft support part 87 that is provided in the opening and closing lever 8, as shown in FIG. 16A and FIG. 16B. Also, the separating mechanism S may include, for example, a spring 37 as shown in FIG. 17.

The support shaft 38 is, for example, a round, bar-shaped member that is the same or substantially the same as the push shaft 36 of the printer 1 of the second embodiment shown in FIG. 15. The support shaft 38 is, for example, positioned upstream of the fixed blade 51 in the forward direction Df of the recording sheet P, and faces the back surface of the fixed blade 51, which faces the opposite direction of the movable blade 52. As shown in FIG. 17, for example, one end of the support shaft 38 is supported by a long hole 39 formed in a side wall of the opening and closing part 3 connected to the body part 2, and the other end of the support shaft 38 is supported by a round hole (not shown) formed in a side wall of the opening and closing part 3. The support shaft 38 is formed such that it can be moved, by means of the long hole 39, between the cutting position shown in the left diagram of FIG. 16B and the upper diagram of FIG. 17 and the free position shown in the right diagram of FIG. 16B and the lower diagram of FIG. 17, for example.

To be more specific, as shown in FIG. 17, one end of the support shaft 38 on the opening and closing lever 8 side is supported by the long hole 39 that extends in a direction to be away from the fixed blade 51 and the movable blade 52. Also, for example, the spring 37 is inserted and fitted in a through-hole 37h formed in the front wall of the opening and closing part 3 and connected to both ends of the support shaft 38. The fixed blade 51 is preloaded toward the movable blade 52 by the preloaded force of the spring 37. By this means, in the cutting position shown in the left diagram of FIG. 16B and the upper diagram of FIG. 17, the support shaft 38 supports the fixed blade 51 at the cutting angle θc at which the distal end 51a of the fixed blade 51 gets closer to the movable blade 52.

Also, the support shaft 38 moves to the free position shown in the right diagram of FIG. 16B and the lower diagram of FIG. 17 and extends the spring 37, by means of the unlocking operation of the opening and closing lever 8. By this means, the preloaded force of the spring 37 connected to one end of the support shaft 38 no longer acts on the fixed blade 51. As a result of this, the distal end 51a of the fixed blade 51 supported by the swing support part 33 swings in the direction of the arrow A4, and is supported at the free angle θo, at which the fixed blade 51 moves away from the movable blade 52 in the separating direction Ds. The round hole in the other end of the support shaft 38 may be provided with a spring so as to serve as a long hole that is the same or substantially the same as the one at the other part of the support shaft 38.

For example, as shown in the left diagram of FIG. 16B, the shaft support part 87 of the opening and closing lever 8 is recessed to support an end of the support shaft 38 that is in the cutting position, while the opening and closing lever 8 is placed in the locking position. Also, the shaft support part 87 is dimensioned and shaped so as to support an end of the support shaft 38 in the free position while the opening and closing lever 8 is placed in the free position, as shown in the right diagram of FIG. 16B, for example.

To be more specific, the inner wall surface 87f of the shaft support part 87 that supports an end of the support shaft 38 has a depth in the axial direction of the rotating shaft 32. This depth of the inner wall surface 87f is dimensioned such that the inner wall surface 87f is constantly in contact with an end of the support shaft 38 and supports the end of the support shaft 38 whether the opening and closing lever 8 is rotated from the locking position to the free position or from the free position to the locking position.

By this means, the shaft support part 87 can move the support shaft 38 from the cutting position shown in the left diagram of FIG. 16B and the upper diagram of FIG. 17, to the free position shown in the right diagram of FIG. 16B and the lower diagram of FIG. 17, by means of an unlocking operation of rotating the opening and closing lever 8 from the locking position shown in the left diagram of FIG. 16B to the free position shown in the right diagram of FIG. 16B.

Also, when the user or the like releases his/her hand from the opening and closing lever 8, the preloaded force of the torsion spring 35 shown in FIG. 6 brings the opening and closing lever 8 from the free position shown in the right diagram of FIG. 16B, back to the locking position shown in the left diagram of FIG. 16B. When this takes place, the spring 37 that has been stretched and elastically deformed contracts, so that the preloaded force acts on the support shaft 38, and the support shaft 38 returns from the free position shown in the right diagram of FIG. 16B and the lower diagram of FIG. 17 to the cutting position shown in the left diagram of FIG. 16B and the upper diagram of FIG. 17.

As described above, according to the printer 1 of this embodiment, the separating mechanism S includes a swing support part 33 that supports the fixed blade 51 such that the fixed blade 51 can swing, a support shaft 38 positioned lengthwise with respect to the movable blade 52, and a shaft support part 87 provided in the opening and closing lever 8. As shown in FIG. 17, the swing support part 33 supports the fixed blade 51 such that the fixed blade 51 can swing between a cutting angle θc, at which the distal end 51a of the fixed blade 51 gets closer to the movable blade 52, and a free angle θo, at which the distal end 51a of the fixed blade 51 moves away from the movable blade 52 in the separating direction Ds. The support shaft 38 is provided such that it can be moved between a cutting position where the support shaft 38 supports the fixed blade 51 at the cutting angle θc and a free position where the support shaft 38 supports the fixed blade 51 at the free angle θo. By means of the unlocking operation of the opening and closing lever 8, the shaft support part 87 of the opening and closing lever 8 supports the support shaft 38 and moves it from the cutting position shown in the upper diagram of FIG. 17 to the free position shown in the lower diagram of FIG. 17.

Structured thus, the printer 1 of this embodiment can bring about the same advantages as those of the printer 1 of the first embodiment described above. To be more specific, when a recording sheet P gets jammed between the fixed blade 51 and the movable blade 52, as shown in FIG. 16B, an unlocking operation is performed in which the opening and closing 8 is rotated from the locking position to the free position. Then, in conjunction with the unlocking operation of the opening and closing lever 8, the shaft support part 87 of the opening and closing lever 8, still supporting the support shaft 38, moves the support shaft 38 from the cutting position to the free position, as shown by the arrow A3 in FIG. 17. As a result of this, as shown by the arrow A4 in FIG. 17, the fixed blade 51 supported by the swing support part 33 swings from the cutting angle θc to the free angle θo, and the fixed blade 51 moves away from the movable blade 52 in the separating direction Ds. By this means, the jamming of the recording sheet P between the fixed blade 51 and the movable blade 52 is cleared, and the opening and closing part 3 can be opened easily and reliably by simply lifting up the opening and closing lever 8 having been rotated to the free position.

Consequently, according to this embodiment, as in the first and second embodiments described above, it is possible to provide a printer 1 in which the opening and closing part 3 can be opened and closed easily and reliably even when the recording sheet P gets jammed.

### Fourth Embodiment

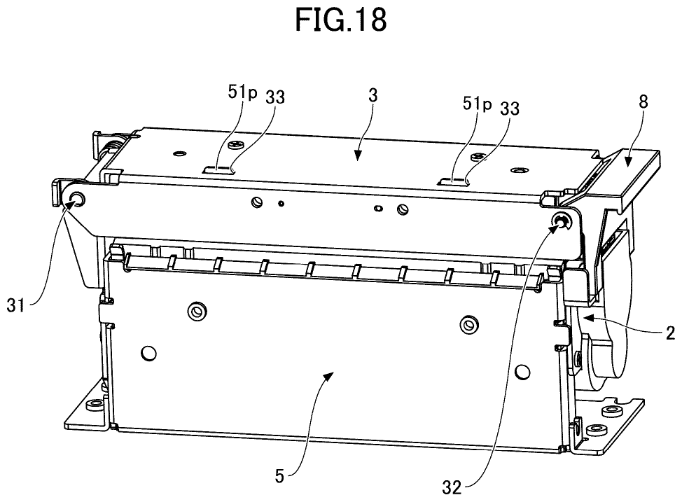

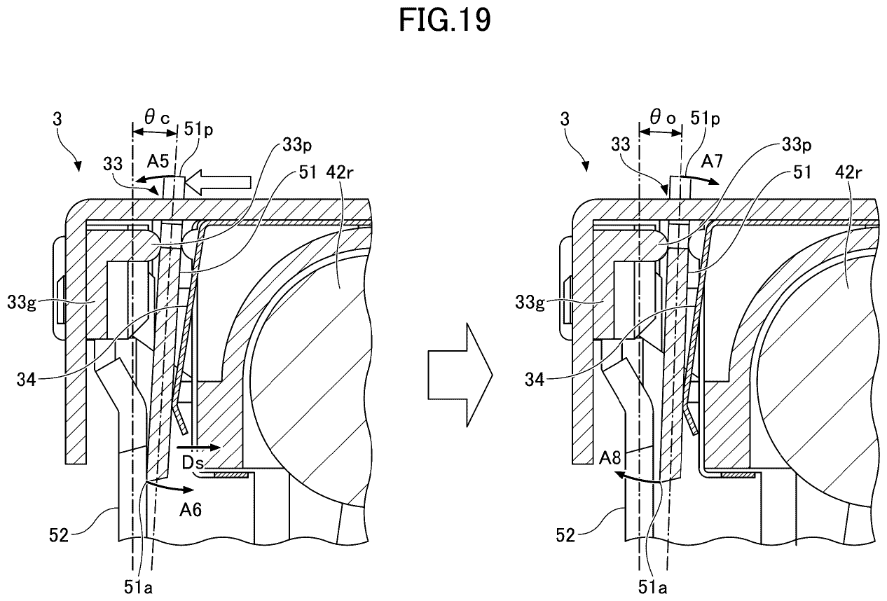

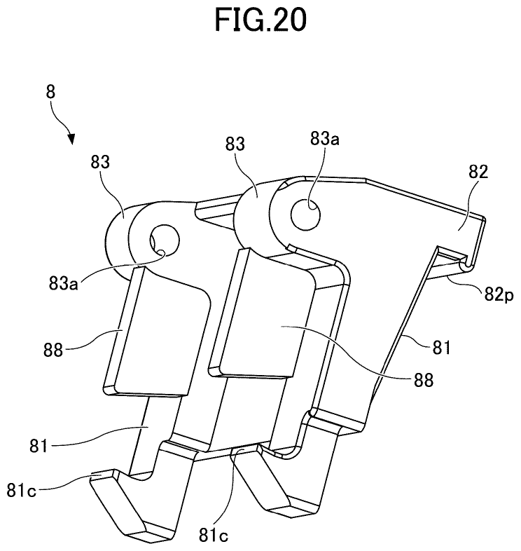

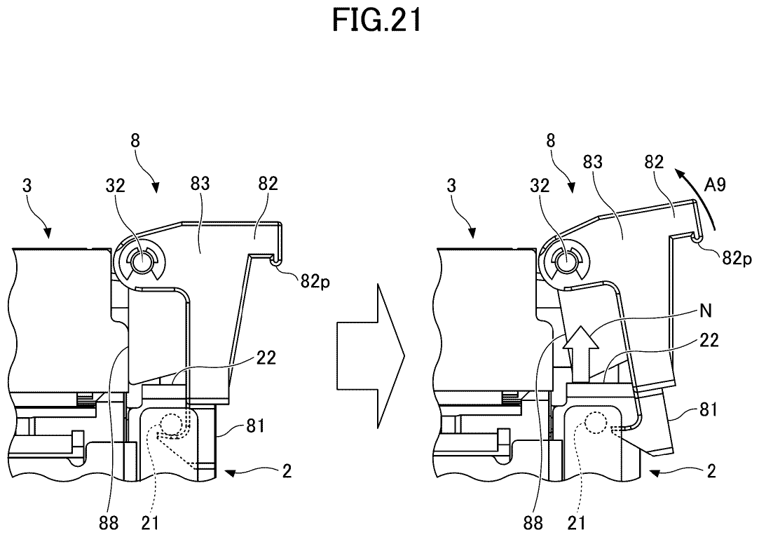

Next, with reference to FIG. 18 to FIG. 21, a printer according to a fourth embodiment of the present disclosure will be described. FIG. 18 is a perspective view of the body part 2 and the opening and closing part 3 showing the fourth embodiment of the printer according to the present disclosure. FIG. 19 is an enlarged cross-sectional view of the fixed blade 51 supported by the opening and closing part 3 shown in FIG. 18. FIG. 20 is a perspective view of the opening and closing lever 8 provided in an end of the opening and closing part 3 shown in FIG. 18. FIG. 21 shows enlarged views of ends of the body part 2 and the opening and closing part 3.

The printer 1 of this embodiment is different from the printers 1 of the first to third embodiments described above in that the fixed blade 51 has operating protrusions 51p that replace the separating mechanism S that separates the fixed blade 51 from the movable blade 52 in the separating direction Ds through the unlocking operation of the opening and closing lever 8. The rest of the structure of the printer 1 of this embodiment is the same or substantially the same as the printers 1 of the first to third embodiments described above, and parts that are the same or substantially the same will be assigned the same or substantially the same reference numerals, accordingly, without further explanation.

Like the printers 1 according to the first and second embodiments described above, the printer 1 of this embodiment has a printing part 4, a fixed blade 51, a movable blade 52, a body part 2, an opening and closing part 3, swing support parts 33, and elastic support parts 34. In addition, in the printer 1 of this embodiment, operating protrusions 51p that are formed in the fixed blade 51 replace the separating mechanism S of the printers 1 according to the first and second embodiments described above.

As shown in FIG. 18 and FIG. 19, the operating protrusions 51p are provided in the opposite end from the distal end 51a of the fixed blade 51 and protrude in the opposite direction with respect to the distal end 51a. Also, in the examples shown in FIG. 18 and FIG. 19, the swing support parts 33 are slit-like through-holes formed in the upper wall of the opening and closing part 3. By inserting the operating protrusions 51p in the swing support parts 33, the fixed blade is supported in a swingable manner.

As shown in FIG. 19, the swing support parts 33 support the fixed blade 51 to swing between a cutting angle θc, at which the distal end 51a of the fixed blade 51 gets closer to the movable blade 52, and a free angle θo, at which the distal end 51a of the fixed blade 51 moves away from the movable blade 52. The operating protrusions 51p of the fixed blade 51 are inserted in the swing support parts 33, for example, to penetrate the upper wall of the opening and closing part 3 and protrude outward from the opening and closing part 3.

As shown in FIG. 19, to separate the fixed blade 51 from the movable blade 52 in the separating direction Ds, the user of the printer 1 or the like pushes the operating protrusions 51p of the fixed blade 51 supported by the swing support parts 33, toward the movable blade 52, that is, in the direction of the arrow A5. Then, the distal end 51a of the fixed blade 51 moves in the direction of the arrow A6 in FIG. 19, with the protrusions 33p of the fixed blade guide 33g serving as fulcrums, the elastic support parts 34 supporting the fixed blade 51 at the cutting angle θc are deformed elastically, and the fixed blade 51 swings from the cutting angle θc shown in the left diagram of FIG. 19 to the free angle θo shown in the right diagram of FIG. 19. As a result of this, a gap is formed between the fixed blade 51 and the movable blade 52.

Also, when the user of the printer 1 releases his/her hand from the operating protrusions 51p of the fixed blade 51, the preloaded force of the elastically-deformed elastic support parts 34 cause the fixed blade 51 to swing from the free angle θo shown in the right diagram of FIG. 19 to the cutting angle θc shown in the left diagram of FIG. 19. As a result of this, the operating protrusion 51p of the fixed blade 51 moves in the direction of the arrow A7, and the distal end 51a of the fixed blade 51 moves in the direction of the arrow A8 and returns to the cutting position, which is close to the movable blade 52, as shown in the left diagram of FIG. 19.

Also, in the printer 1 of this embodiment, as shown in FIG. 18 and FIG. 20, the opening and closing lever 8 has engaging parts 81, a holding part 82, and pivotally-supported parts 83, as the opening and closing levers 8 of the printers 1 of the first embodiment to the third embodiment described above do. Also, in the printer 1 of this embodiment, the opening and closing lever 8 has contact parts 88. Each contact parts 88 is formed in a substantially rectangular plate-like shape, extending from the pivotally-supported part 83 toward the upper surface 22 of the body part 2, when the opening and closing lever 8 is placed in the locking position, for example, as shown in the left diagrams of FIG. 20 and FIG. 21.

Referring to the left diagram of FIG. 21, when the opening and closing lever 8 is placed in the locking position, the distal surface of each contact part 88 faces the upper surface 22 of the body part 2 and is inclined, for example, with respect to the upper surface 22 of the body part 2. To be more specific, when the opening and closing lever 8 is placed in the locking position, the distal surface of the contact part 88 is inclined with respect to the upper surface 22 of the body part 2, such that, for example, the distance between the distal surface of each contact part 88 and the upper surface 22 of the body part 2 decreases nearer to the center of the opening and closing part 3 in the longitudinal direction of the opening and closing part, which corresponds to the longitudinal direction of the fixed blade 51.

The contact part 88 is configured to contact the upper surface 22 of the body part 2 during an unlocking operation, in which the user lifts the holding part 82 of the opening and closing lever 8 in the direction of the arrow A9 in FIG. 21 and rotates the opening and closing lever 8 from the locking position shown in the left diagram of FIG. 21 to the free position shown in the right diagram of FIG. 21. To be more specific, the positions where the contact parts 88 contact the upper surface 22 of the body part 2 during the unlocking operation of the opening and closing lever 8 are located between the rotating shaft 32 and the holding part 82 in the longitudinal direction of the opening and closing part 3, and located closer to the rotating shaft 32 than to the holding part 82.

As described above, the printer 1 of this embodiment has a printing part 4, a fixed blade 51, a movable blade 52, a body part 2, an opening and closing part 3, a holding part 82, swing support parts 33, and elastic support parts 34, as the printers 1 of the first embodiment to the third embodiment described above do. The printing part 4 prints on a recording sheet P, and the fixed blade 51 and the movable blade 52 cut the recording sheet P printed by the printing part 4. The body part 2 supports the movable blade 52, and the opening and closing part 3 supports the fixed blade 51 and is connected to the body part 2 such that the opening and closing part 3 can be opened and closed. The swing support part 33 supports the fixed blade 51 such that the fixed blade 51 can swing between a cutting angle θc at which the distal end 51a of the fixed blade 51 gets closer to the movable blade 52 and a free angle θo at which the distal end 51a of the fixed blade 51 moves away from the movable blade 52. The elastic support parts 34 support the fixed blade 51 at the cutting angle θc. The fixed blade 51 has operating protrusions 51p that are formed in an opposite end of the distal end 51a and protrude outward with respect to the opening and closing part 3. When the operating protrusions 51p of the fixed blade 51 supported by the swing support part 33 are pushed in the direction of the movable blade 52, the elastic support parts 34 are deformed elastically, and the fixed blade 51 swings from the cutting angle θc to the free angle θo.

Structured thus, according to the printer 1 of this embodiment, for example, when a recording sheet P gets jammed between the fixed blade 51 and the movable blade 52 and the movable blade 52 is unable to return to the standby position, the user of the printer 1 or the like is allowed to maneuver the operating protrusions 51p of the fixed blade 51 to clear the jamming of the recording sheet P. To be more specific, the user pushes the operating protrusions 51p of the fixed blade 51 in the direction of the arrow A5 in FIG. 19. Then, the distal end 51a of the fixed blade 51, supported by the swing support part 33 such that the fixed blade 51 can swing, moves in the direction of the arrow A6, the elastic support parts 34 are deformed elastically, and the fixed blade 51 moves in the separating direction Ds and moves away from the movable blade 52. As a result of this, a gap is formed between the fixed blade 51 and the movable blade 52, and the jamming of the recording sheet P between the fixed blade 51 and the movable blade 52 is cleared. Consequently, according to the printer 1 of this embodiment, it is possible to separate the movable blade 52 from the fixed blade 51 by using a simple compared the structure conjunctional mechanism of existing printers composed of a large number of parts.

Also, like the printer 1 of the first to third embodiments described above, the printer 1 of this embodiment also has an opening and closing lever 8. The opening and closing lever 8 is rotatably provided at the end of the opening and closing part 3 that is opposite from the end of the opening and closing part 3 connected to the body part 2, and rotates between a free position where the opening and closing part 3 can be opened and closed and a locking position where the opening and closing part 3 is fixed to the body part 2.

Structured thus, in the printer 1 of this embodiment, the opening and closing lever 8 placed in the locking position can be moved to the free position, so that the opening and closing part 3 can be opened and closed with respect to the body part 2.

Furthermore, in the printer 1 of this embodiment, the opening and closing lever 8 has engaging parts 81, a holding part 82, pivotally-supported parts 83, and contact parts 88. The engaging parts 81 extend along the sides of the opening and closing part 3 when the opening and closing lever 8 is placed in the locking position and engage with the sides of the body part 2. The holding part 82 is formed in the proximal end of the engaging part 81 adjoining the opening and closing part 3, and protrudes in a direction to be away from the sides of the opening and closing part 3. Each pivotally-supported part 83 protrudes from the proximal end of the corresponding engaging part 81, in the opposite direction with respect to the holding part 82, and is supported pivotally by the opening and closing part 3. The contact parts 88 extend from the pivotally-supported parts 83, toward the upper surface 22 of the body part 2, when the opening and closing lever 8 is placed in the locking position, and contact the upper surface 22 of the body part 2 during an unlocking operation, in which the opening and closing lever 8 is rotated from the locking position to the free position.

Structured thus, the printer 1 of this embodiment can, for example, clear jamming of a recording sheet P between the fixed blade 51 and the movable blade 52 by maneuvering the operating protrusions 51p formed in the fixed blade 51. Furthermore, when the opening and closing lever 8 is operated to open or close, the contact part 88 contacts the upper surface 22 of the body part 2 during the operation. Then, as shown in the right diagram of FIG. 21, a vertical force N acts on the contact parts 88 from the upper surface 22 of the body part 2 in conjunction with the unlocking operation of the opening and closing lever 8. As a result of this, based on the principle of leverage, a force in the direction to open the opening and closing part 3 can be applied to the rotating shaft 32 of the opening and closing part 3, which pivotally supports the pivotally-supported part 83 of the opening and closing lever 8. Consequently, according to the printer 1 of this embodiment, the unlocking operation of the opening and closing lever 8 for opening the opening and closing part 3 requires less energy, making it possible to open the opening and closing part 3 with more ease.

As described above, according to the herein-contained embodiments of the present disclosure, it is possible to provide a printer 1 that can separate the fixed blade 51 from the movable blade 52 using a simple structure.

All examples and conditional language provided herein are intended for the purpose of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

For example, the opening and closing lever of the printer of the fourth embodiment may be provided with the contact part that the opening and closing lever of the printer of the first embodiment to the third embodiment has. By this means, the printer of each embodiment can reduce the energy that is required when performing the unlocking operation of the opening and closing lever to open the opening and closing part, and separate the fixed blade from the movable blade, open the opening and closing part, and so forth, with more ease. Also, the operating protrusions formed in the fixed blade of the printer of the fourth embodiment may also be formed in the fixed blade of the printer of the first embodiment to the third embodiment. This allows the user of the printer 1 or the like to cope with various situations such as ones in which a paper jam occurs or a sheet of paper gets caught, by maneuvering the operating protrusions and the opening and closing lever together or by maneuvering either one of them. Also, a head unit may be provided in the opening and closing part, and a platen unit may be provided in the body part. By this means, it becomes easy to check the printed content while printing is in progress.

What is claimed is:

1. A printer comprising:
a printing part configured to print on a recording sheet;
a fixed blade and a movable blade configured to cut the recording sheet printed by the printing part;
a body part that supports the movable blade;
an opening and closing part that supports the fixed blade and has a first end connected to the body part of the printer such that the opening and closing part is allowed to open and close;
an opening and closing lever provided at a second end of the opening and closing part opposite the first end, and configured to rotate between a free position for allowing the opening and closing part to open and close, and a locking position for fixing the opening and closing part to the body part; and
a separating mechanism configured to separate the fixed blade from the movable blade in a separating direction in conjunction with an unlocking operation of the opening and closing lever in which the opening and closing lever is rotated from the locking position to the free position, the separating direction intersecting with an operating direction in which the movable blade moves.

2. The printer according to claim 1, wherein the first end of the opening and closing part connected to the body part and the second end of the opening and closing part at which the opening and closing lever is provided are opposite ends in a longitudinal direction of the fixed blade.

3. The printer according to claim 1, wherein the separating mechanism includes:
a preloading part configured to preload the fixed blade in a direction opposite to the separating direction; and
a push part configured to push the fixed blade in the separating direction when the opening and closing lever is placed in the free position.

4. The printer according to claim 3, wherein the push part is a protruding part formed in the opening and closing lever.

5. The printer according to claim 3,
wherein the push part includes:
a push shaft that extends in a longitudinal direction of the fixed blade; and
a shaft-push part formed in the opening and closing lever,
wherein the push shaft is configured to move between a push position to push the fixed blade in the separating direction and a non-push position to adjoin the fixed blade placed in a cutting position where the fixed blade is able to cut the recording sheet, and
wherein the shaft-push part is configured to move the push shaft from the non-push position to the push position through the unlocking operation of the opening and closing lever.

6. The printer according to claim 1,
wherein the separating mechanism includes:
a swing support part that supports the fixed blade such that the fixed blade is allowed to swing between a cutting angle and a free angle, a distal end of the fixed blade coming into contact with the movable blade when the fixed blade is at the cutting angle, and being separated from the movable blade in the separating direction when the fixed blade is at the free angle;
a support shaft positioned in a longitudinal direction of the fixed blade; and
a shaft support part formed in the opening and closing lever,
wherein the support shaft is configured to move between a cutting position where the fixed blade is supported at the cutting angle and a free position where the fixed blade is supported at the free angle, and
wherein the shaft support part supports the support shaft through the unlocking operation of the opening and closing lever and moves the support shaft from the cutting position to the free position.

7. The printer according to claim 1, wherein the opening and closing lever includes:
an engaging part that extends along a side surface of the opening and closing part and engages with a side of the body part when the opening and closing lever is placed in the locking position; and
a holding part that is formed at a proximal end of the engaging part adjoining the opening and closing part, and that protrudes away from the side surface of the opening and closing part.

8. The printer according to claim 7, wherein the opening and closing lever further includes a secondary protrusion that is formed at the proximal end of the engaging part and that protrudes at an obtuse angle to the holding part on an opposite side from a distal end of the engaging part.

9. The printer according to claim 7, wherein the opening and closing lever further includes:
a pivotally-supported part that protrudes from the proximal end of the engaging part in a direction opposite to the holding part and is pivotally supported by the opening and closing part; and
a contact part that extends from the pivotally-supported part toward an upper surface of the body part when the opening and closing lever is placed in the locking position, and contacts the upper surface of the body part partway through the unlocking operation of the opening and closing lever.

10. A printer comprising:
a printing part configured to print on a recording sheet;
a fixed blade and a movable blade configured to cut the recording sheet printed by the printing part;
a body part that supports the movable blade;
an opening and closing part that supports the fixed blade and has a first end connected to the body part such that the opening and closing part is allowed to open and close;
an opening and closing lever provided at a second end of the opening and closing part opposite the first end, and configured to rotate between a free position for allowing the opening and closing part to open and close, and a locking position for fixing the opening and closing part to the body part;
a cutter driving part configured to move the movable blade between a standby position where the movable blade is placed before cutting of the recording sheet begins and an end position where the cutting the recording sheet ends;
a movable blade sensor configured to detect the standby position and the end position of the movable blade; and
a control part configured to control the cutter driving part to bring the movable blade back to the standby position when the movable blade fails to move from the standby position and reach the end position within a predetermined period of time.

11. The printer according to claim 10, further comprising an open and close sensor configured to detect whether the opening and closing part is open or closed,
wherein the control part controls the cutter driving part to bring the movable blade back to the standby position when the opening and closing part is closed, the movable blade is not in the standby position, and the closed opening and closing part opens, based on detection results from the movable blade sensor and the open and close sensor.

12. A printer comprising:
a printing part configured to print on a recording sheet;
a fixed blade and a movable blade configured to cut the recording sheet printed by the printing part;
a body part that supports the movable blade;
an opening and closing part that supports the fixed blade and has a first end connected to the body part such that the opening and closing part is allowed to open and close;
a swing support part that supports the fixed blade such that the fixed blade is allowed to swing between a cutting angle and a free angle, a distal end of the fixed blade coming into contact with the movable blade when the fixed blade is at the cutting angle, and being separated from the movable blade when the fixed blade is at the free angle; and
an elastic support part that supports the fixed blade at the cutting angle,
wherein the fixed blade has an operating protrusion that is formed at an opposite end of the fixed blade from the distal end, and that protrudes outward with respect to the opening and closing part, and
wherein the operating protrusion of the fixed blade supported by the swing support part is pushed toward the movable plate, so that the elastic support part is deformed elastically and the fixed blade swings from the cutting angle to the free angle.

13. The printer according to claim 12, further comprising an opening and closing lever provided at a second end of the opening and closing part opposite the first end, and configured to rotate between a free position for allowing the opening and closing part to open and close, and a locking position for fixing the opening and closing part to the body part.

14. The printer according to claim 13, wherein the opening and closing lever includes:
an engaging part that extends along a side surface of the opening and closing part and engages with a side of the body part when the opening and closing lever is placed in the locking position;
a holding part that is formed at a proximal end of the engaging part adjoining the opening and closing part, and that protrudes away from the side surface of the opening and closing part;
a pivotally-supported part that protrudes from the proximal end of the engaging part in an opposite direction with respect to the holding part and is pivotally supported by the opening and closing part; and
a contact part that extends from the pivotally-supported part toward an upper surface of the body part when the opening and closing lever is placed in the locking position, and contacts the upper surface of the body part partway through the unlocking operation of the opening and closing lever.
